(19) United States
(12) Patent Application Publication
(10) Pub. No.: US 2002/0121336 A1
(43) Pub. Date: Sep. 5, 2002

(54) System and method for multidimensional imagery

(76) Inventors: William M. Karszes, Rosewell, GA (US); Jerry C. Nims, Atlanta, GA (US)

Correspondence Address: PATTON BOGGS LLP, 2550 M. Street, NW, Washington, DC, 20037-1350, US

(21) Appl. No.: 10/025,835

(22) Filed: Dec. 26, 2001

Related U.S. Application Data
(60) Provisional application No. 60/257,163, filed on Dec. 22, 2000.

(51) Int. Cl. B41M 1/00

(52) U.S. Cl. 156/277

(57) ABSTRACT

A plurality of parameters including boundary values and performance values particular to a specific user application, are input to a computer that generates a MOM design using ray trace, an image pixel format and arrangement corresponding to that MOM design is generated, the MOM is manufactured, the image is processed and printed on the MOM in accordance with the generated image pixel format.

Priority of this application is based on U.S. Provisional Application No. 60/257,163, filed on Dec. 22, 2000, which is hereby incorporated by reference.

### BACKGROUND OF THE INVENTION

1. Field of the Invention

The present invention relates to microlens media and, more particularly, to a method for fabricating microlens sheets and formatting digital image and print data based on boundary conditions representing physical factors, image factors, and cost factors particular to a user's application.

2. Statement of the Problem

Lenticular sheets, or films, have been known in the art of image display for a considerable time. Description of the structure and optical theory by which a lenticular sheet functions is readily found in the available literature. Example literature includes Computer Generated Lenticular Stereograms, Non-Holographic True Three-Dimensional Display Technologies, W. E. Robbins, Proc. SPIE, 1083 (1989).

A lenticular sheet as known in the art consists of a plurality of semi-cylindrical lenses, or lenticules, extending parallel to one another on a top surface of a transparent plastic sheet. The lenticular sheet functions to refract a specially formatted image, which the sheet overlays or which is printed on the bottom of the sheet, such that an observer sees it as a three dimensional image or sees an image which changes as the observer changes his or her position relative to the sheet.

In practice a lenticular sheet having N lenticules overlays, or has printed on its bottom surface, a plurality of M rasterized images, each image formed of N lines. In one known basic implementation, the M rasterized images are interlaced and aligned with the N-lens lenticular sheet such that each lenticule covers M raster lines, consisting of one raster line from each of the M images. The M images may show different movement positions of an object or person, or may show different degrees of zoom. The M images may also show a left eye view and a right eye view of the same scene.

The lenticules refract light rays illuminating and reflected from the raster lines such that each raster line can be seen only within a given acceptance angle surrounding a particular viewing angle relative to the plane of the lenticular sheet. The viewing angle is determined by the offset of the raster line with respect to the longitudinal axis of the lenticule. The N raster lines of each of the M images can therefore be positioned under the N lenticules such that M viewing angles are established, with each viewing angle being a position from which the raster lines of only one of the M images can be seen. This allows observers to see images which change as the observer changes his or her position with respect to the medium. Alternatively, the raster lines can be positioned such that from at least one viewing angle the raster lines of one image are seen by an observer's left eye while, at the same time, the raster lines of another image are seen by the observer's right eye. Typically the two images are of the same scene, but differing by the parallax that an observer's left and eye and right eye would experience if viewing that scene in an actual three dimensional space. The result is that the viewer perceives three dimensions, without having to wear special glasses.

Historically, the basic pieces of the overall technology have been solved only within a limited field, i. e., lenticular material has been provided in thick lens configurations because of limitations in plastic processing, or because the dot structure provided by known processes have limited the lens spacing, or because interphasing programs have been developed to manipulate layered images based upon implicit constraints in the lens configuration and without regard to the physiology of the human eye. Each of these approaches presents economic and technical problems, and obstacles, to the availability of lenticular media to the masses.

Another problem is that the lenticular sheets are typically manufactured to standardized specifications. Such specifications are typically evolved from a combination of dot structures from printing with a minimization of cost relative to thickness and process technology. In this case the lenses, dot structure and imagery have not been optimized relative to one another and relative to a particular end application. This lack of optimization and evaluation has tended to block the growth of microlens technology.

### SUMMARY OF THE INVENTION

For purposes of this description the term “Micro Optical Material” or “MOM” will mean any sheet having an array of microlenses, of which the traditional lenticular sheet is one type. The MOM lenses may be spherical or aspherical. Other types of MOMs include, but are not limited to, fly eye lenses and any other array of lenses that refracts images to present different information to each eye.

The present invention encompasses a method which inputs a plurality of parameters including boundary values and performance values particular to a specific user application, generates a MOM design and an image pixel format corresponding to that MOM design, manufactures the MOM, processes and prints the image on the MOM in accordance with the generated image pixel format.

One aspect of the invention is a method for displaying an image through a microlens sheet, including the steps of inputting a physical constraint data into a retrievable storage device, inputting an image quality data into a retrievable storage device, and retrieving the physical constraint data and the image quality data into a programmable data processor. The retrievable storage device, or devices, may be the conventional data storage included in commercially available general purpose programmable computers.

Next, a microlens specification data is calculated, based on the retrieved physical constraint data and the retrieved image quality data, utilizing the programmable data processor. A microlens processing tool specification data is then calculated based on the calculated microlens specification data, and a microlens processing tool is formed based on the calculated microlens processing tool specification data. Next, a microlens sheet is formed utilizing the microlens processing tool. A digitized image is then input into a retrievable storage medium. The digitized image is then retrieved into a programmable data processor, and the digitized image is formatted into a pixel array based on the calculated microlens specification data. The pixel array is then output to a printing device, which then prints the outputted pixel array on a printable medium. The printed outputted pixel array is then displayed through the microlens sheet.

Accordingly, an objective of the present invention is a method for producing microlens sheets in accordance with a user's particular image quality, cost and performance constraints.

Another objective of this invention is a method for formatting and arranging a pixel image based on the particular microlens sheet generated for the user's particular requirements.

Still another objective of this invention is a method for producing a microlens sheet, and formatting and arranging a pixel image for display through the sheet, optimized based on human visual parameters.

### BRIEF DESCRIPTION OF THE DRAWINGS

These and other objects of the invention will be clear upon a reading of the following detailed description of several preferred embodiments of the invention, together with the following drawings of which:

FIG. 1 shows an example functional flow chart of a method according to the present invention for producing a microlens product; and

FIG. 2 shows an example functional flow chart of a block within the FIG. 1 high level flow chart.

### DETAILED DESCRIPTION OF THE INVENTION

1. Overview

To provide a better understanding of this invention and its novel aspects, this description omits unnecessary description of the background known methods and processes by which lenticular sheets are manufactured, and by which pictures, or computer generated images, or combinations of both, are digitized and processed into the format required for viewing through a lenticular sheet. The description instead focuses on the novel aspects of the invention, to better assist one of ordinary skill in the arts to which it pertains in understanding its features and operation.

The invention, in one of its general forms, comprises a method in which parameters defining an image to be displayed, and other application-specific information, including boundary values defining, for example, cost, material and equipment constraints, are input into a software module running on a general purpose programmable computer, or a network or other linked arrangement of the same. Based on the entered parameters and constraints a microlens specification, defining a MOM, is generated. Tooling data defining specific tooling for extruding MOM sheets in accordance with the microlens specification data is generated and the tooling is formed in accordance with the same. A digital pixel-based image is generated, or converted into digital form from an analog media. The pixel-based image is formatted for deposition onto, or under, the MOM, with the pixel arrangement and spacing being based, at least in part, on the particular microlens specification data, the printing apparatus being used, the image characteristics, and factors based on, or characterizing, the human eye and its perception of the desired image display. The image is then printed for display through the MOM.

2. Detailed Description

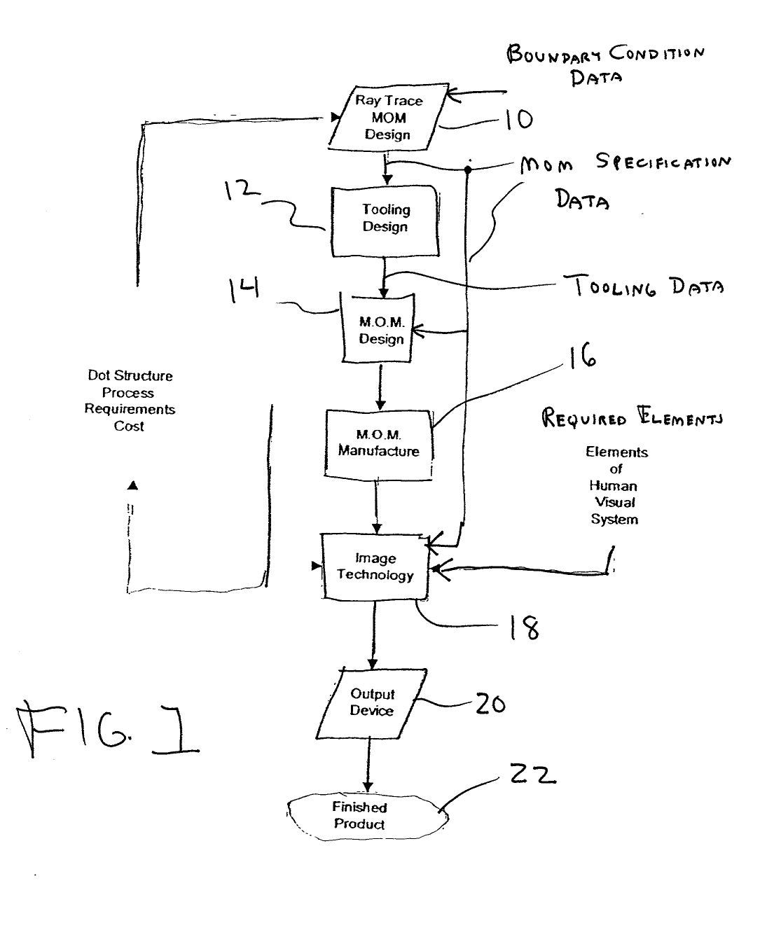

FIG. 1 shows an example high level functional flow chart example of a method according to the present invention. Step 10 is a MOM design step which receives Boundary Condition Data including Physical Constraint Data and Image Constraint Data and then, using ray tracing, generates a MOM Specification Data defining a geometry and set of dimensions for a MOM meeting the requirements of a user's particular application. The Physical Constraint Data for this ray tracing step 10 are determined by the factors governing the output device, process requirements, physical and structural requirements of the MOM, and any existing machinery requirements and above all the cost requirements. This same information is inputted into the image technology module block 18, described further below.

Step 10 is carried out according to the following functional equations (1) through (8).

Q=quality of viewed image. (1)

Q is a subjective number, ranging, for example, from 1 to 5. Q is a value placed on the perceived quality of the image, or the ability to use the image for measurement and construction.

Q=q(CI, RI, RO, MP, O, DP), where (2)

CI=composition of image, which includes depth cues in 3D, depth points in 3D, roundness, sharpness of transition in flips and animation,

RI=input resolution, including number of pixels, frames and layers used for defining the image,

RO=output resolution, which represents the output pixel resolution, image frames and output device,

O=optics of the system. The optics accounts for the printing device, cost and customer application,

MP=material parameters that influence the output application as well as the quality of image,

DP=digital pattern, which is the printed pattern for the dots creating the image. The dot pattern includes screen ruling, screen angles, dot size, and dot shape. This parameter accounts for device outputs, process constraints and end application.

CI=ci(NL, NF, C, VQ, LPI, P), where (3)

NL=number of layers id image, which represents depth points,

NF=number of frames used to interphase the imagery,

C=color, composition,

VQ=visual cues,

LPI=lenses per inch, and

P=parallax.

RI=ri(NF, IR, LPI), where (4)

NF=number of frames used to interphase,

IR=input resolution, pixels, and

LPI=lenses per inch.

RO=ro(LPI, DPI, NF), where (5)

DPI=dots per inch.

O=o(n, LPI, FL, S1, ), where (6)

n=index of refraction of MOM material,

FL=focal length or thickness of MOM,

S1=shape factor, such as cylindrical, aspherical, fly's eyes, others, and

=acceptance angle.

MP=mp(T, LPI, C, PP, S2), where (7)

T=optical transmittance of MOM material,

C=color,

S2=finished product lens shape, and

PP=physical properties of MOM material.

DP=dp(DPI, DG, PDP, LPI, RG), where (8)

DG=dot gain,

PDP=printed dot position, (analog—screen angles, stochastic—digital).

Further, it should be understood that RI is also a function of CI and, therefore,

Q=q(CI, MRO), with RI and RO being boundary conditions. (9)

The ray tracing employed within step 10 generates the MOM Specification Data, defining the lens array and optimizing the MOM thickness relative to the RO function. The ray tracing also optimizes the information behind the lens relative to a person's eyes.

Next, at step 12, Tooling Data is generated and tooling is formed to specific criteria established and bounded by the manufacturing processes. The tooling design operation, i.e., Tooling Data generation, of step 12 accounts for manufacturing tolerances to replicate the MOM designed by the ray trace program at step 10 within a predetermined accuracy. Example causes of manufacturing tolerances are shrinkage factors and spherical aberrations. The tooling design operation of step 12 also accommodates the particular cutting process used for the MOM manufacturing, e.g., extrusion process, performed at step 16.

The tooling designed and manufactured at step 12 may be an extrusion cylinder of a type such as described in the Background section of U.S. Pat. No. 5,362,351, which is hereby incorporated by reference. Such an extrusion cylinder is used for rolling plastic in an industrial forming process for lenticular sheets. The extrusion cylinder consists of a metal cylinder that has been inscribed with a plurality of grooves, the plurality being the inverted profile of the array of optical elements defined by the MOM Specification Data generated at step 10, to be formed by the extrusion of a transparent material. As can be understood by one of ordinary skill to which this invention and that of U.S. Pat. No. 5,362,351 pertain, design factors must be included in the tooling design to create a crisp lens.

An example manufacturing of an extrusion cylinder by step 12 is as follows: A starting cylinder (not shown) from which the cylinder is formed is mounted on a lathe (not shown) and engraved with a diamond-tipped tool (not shown) that has the cutting profile of one lens element. Tooling design parameters preferably include the material of the extrusion cylinder or other tool, design factors for shrinkage due to cooling. Thus, materials such as copper must be sufficiently soft to be cut clearly, but sufficiently hard to stand up to wear and tear of normal processing. A wear resistant coating such as nickel or chrome is applied to the finished cylinder. The plating thickness must be accounted for in the design of the cutting tool. It should be noted that cooling across the cylinder needs to be controlled so that shrinkage is controlled across the face.

The engraving operation itself is known in the art. In the preferred embodiment, the diamond-tipped tool is repositioned for multiple cuts into the cylinder at a fixed interval that is in accordance with the lens spacing generated at step 10. It must be emphasized that a rigid, accurate lathe or engraving machine is required for step 12. The machine requirements include the ability to step and repeat so concentric patterns can be cut into the lens array cylinder. Precise control of the step is also required so that pattern replication is precise. In addition, cutting head design is critical so that the depth of the cut is well-controlled. Similarly the material for the cylinder must be selected such that each cut is clean and uniform.

Another example for the tooling designed and manufactured at step 12 is knurled tooling for fly's eyes lenses.

Next, at step 14, the specific MOM design generated at step 10 is optimized relative to the finished product and/or process parameters. Factors on which the optimization is based are single layer versus multi-layer construction, materials and cost.

Next, step 16 manufactures the MOM. To produce a MOM with a uniform lens array, the material from which the MOM is formed must replicate the surface of the tooling uniformly and reproducibly. This can be accomplished by always keeping pressure on the molten material during the solidification process. Such processes are described in U.S. Pat. Nos. 5,362,351 and 6,060,003, which are hereby incorporated by reference. Step 16 is preferably carried out using MOM materials meeting the appropriate boundary conditions of the output process, such as heat distortion, mechanical stability, ink receptivity, surface hardness, color stability, UV stability, curl, processability and cost. Practical limitations exist within this phase relative to factors such as thickness of layers in multi layer structures, thickness of the lens material relative to the depth of the lenses, type of material in single layer structures.

Next, step 18, labeled for purposes of reference only as the Image Technology Module, receives Output Device parameters, describing the user's printing device, and MOM Design Data, generated by the step 10 ray trace, the Input Image data defining the image that the user wishes to display through the MOM, and generates an Interphased Output Image data for printing on the MOM or, in a variation of this invention, for printing on another ink receptive surface (not shown) onto which the MOM is affixed.

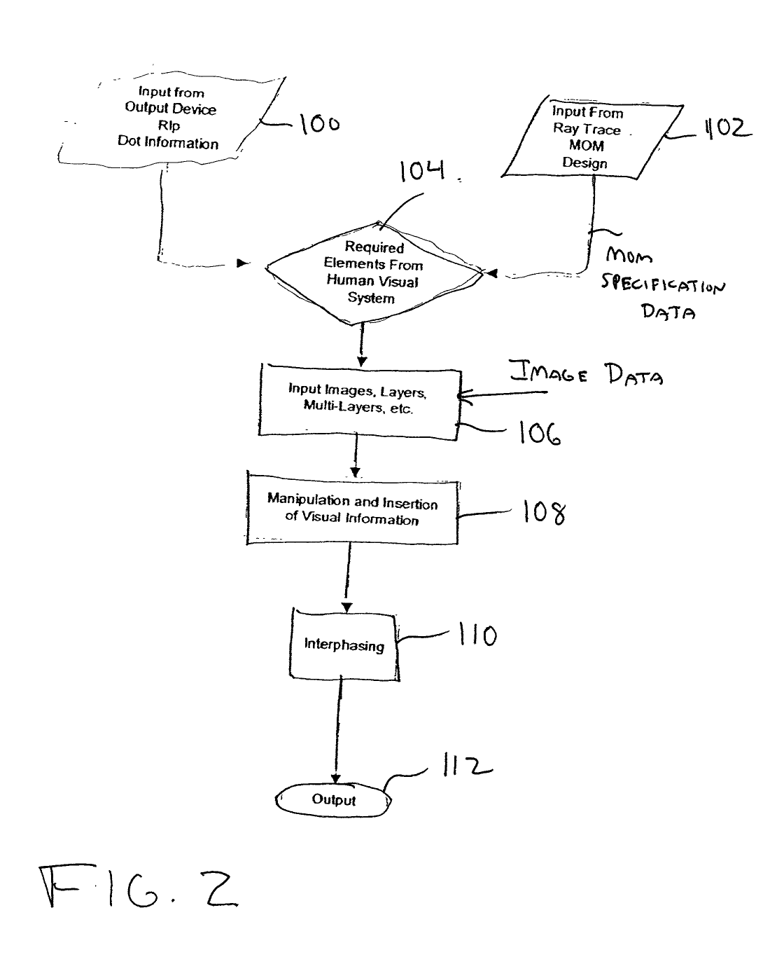

FIG. 2 shows an example of the FIG. 1 step 18 Image Technology Module. As shown, the step 18 Image Technology Module combines information shown in block 100 as received from the user's output device, and “rip dot information,” which creates the dot pattern for a particular printer dot pattern e.g., an ink jet printer or the like, and MOM Specification Data shown in block 102 as received from the ray trace MOM design carried out by steps 10 and 14, which are shown in FIG. 1. The Image Technology Module 18 is typically carried out on a general purpose programmable computer (not shown) local to the end user, but this is not the only computer resource environment contemplated by the invention.

As shown in FIG. 2, the information received from blocks 100 and 102 is combined at block 104 in accordance with one or more parameters describing the Human Visual System, referenced herein as “the Required Elements”, to optimize the requirements of the final image.

The Required Elements preferably include: 1) maximum parallax without distortion, which is obtained from the ray trace and RO function); 2) depth points, which are added to minimize parallax while minimizing apparent depth (layers); 3) monocular clues, which are perspective elements that draw the eye into the depth; 4) color, where changing color from light (foreground) to dark (background) will add depth and roundness; 5) crisp ranges that are not outside the visual disparity of the eye and visual system.

The term “optimize” within the combining step of block 104 means to add appropriate ones of the Required Elements to minimize the amount parallax in the image while maximizing the depth to the human visual system. The optimization and choice of appropriate ones of the Required Elements is based on at least the LP, DPI of output and the chosen path through the prepress (RIP) system. For example, when step 104 is presented with a problem of low resolution in DPI, the LPI must go down. If the LPI goes down, MOM thickness goes up, which infers cost goes up. Thus, the user returns to step 10, and minimizes the thickness of the MOM using lens design and ray tracing. Then, to add depth, more monocular cues, color cues and framing are used.

The combining operation of step 104 provides for coding the information within the given dots to optimize the output information to the eye. For example, if the MOM lens array is 60 LPI with an aspherical lens and a shoulder at 10 mils thick printed on a 720 dpi device, 12 dots can be used behind each lens. Step 104 flows toward optimization of the information contained in those 12 dots to produce the maximum effect as the light patterns are refracted through the lens and seen by the human eyes. The visual percepts seen are a function of the patterns of light received at the retina, so the arrangement of those patterns inherently affects the resultant percept.

Next, at step 106 the input images are input to the Image Technology Module 18. The images are then, at step 108, manipulated per the requirements inputted from the information streams. The manipulated images are then, at step 110, interphased into the appropriate multi-dimensional image and outputted at step 112. In terms of flips, animations, step 110 uses the ray traces within the MOM Specification Data from step 10 to sequence the images or to add neutral tones. Also step 110 adds similar images in adjacent frames to freeze images at the end sequence or highlight sequences. Placement of text in layers, though, and not interphase also adds depth while maintaining visual clarity. Referring to FIG. 1 the interphased output of FIG. 2 step 112 is input to an output device such as an ink-jet printer, which is shown as block 20. The output device then generate, as shown at block 22, a finished product.

As described, the method of the present invention basically starts with what is available, i.e., the given output device and associated boundary conditions of the output device, and asks what is the appropriate lens array that meets both the economic requirements and the boundary conditions of the output device. This is accomplished through the FIG. 1 step 10 ray trace analysis that starts with a given thickness and spacing requirement. Any type of array can be designed to meet these requirements. The lenses can be cylindrical (so called lenticular, aspherical and aspherical with a shoulder, fly's eye or any other such array. Basically, any array designed and optimized within the guidelines of optical ray trace programs can be used.

### EXAMPLE # 1

It is known that flexographic printing requires a flexible material capable of withstanding web fed tensions during processing. Flexographic printing is a continuous web press printing process using rubber plates to transfer the ink to the print medium. The process uses rubber plates that under normal circumstances can only produce a 22-226 line screen pattern. The initial MOM design was for a 140 DPI at 8 to 9 mils. The parallax used was on the order of 0.2 inches in the foreground and 0.3 inches in the background. Before applying the method of this invention to the problem, the present inventors could produce excellent 3D images at the match print stage, but could not reproduce on the actual printing press.

Applying a high parallax to a computer generated image causes problems in two areas. 1) If the dots overlap behind the lens then the image is muddy and fuzzy. The overlap is due to dot size and/or dot gain) 2) If the parallax is high, registration and pitching to the lens array is critical. The holding of the registration from a machine error analysis will produce ghosting or switching images. Thus to reduce this problem monocular cues, depth points, and light-to-dark shading is used to reduce the need for parallax. The alternate way to do this is to reduce the number of frames. However as the number of frames is reduced the amount of parallax needs to be reduced to prevent visual disparity, which is the ability of the eyes to fill in the information. The present inventors applied appropriate Required Elements of the Human Visual System patterns to the imagery, mainly monocular cues and lighting cues.

The depth of the new images was equivalent or better than the previously mentioned images yet the parallax was 0.1 in the foreground and 0.2 in the background. This represents a 40% reduction of parallax. This reduction in parallax provided successful print imagery on the flexographic press to a higher level than previously seen.

### EXAMPLE 2

Inkjet printers print at a nominal level of 720 dpi The 72-dpi translates to ten (10) images at sixty (60) lenses per inch. The normal LPI=60 is a 54-mil lens. The 54-mil lens is too thick to be printer on an ink jet printer as well as being too thick for normal coating machines that apply the specialized coating required for direct printing on the lens. Lastly, the cost of a 54-mil material is too costly for general consumption. The method of FIGS. 1 and 2 devised an LPI=60 lens using a spherical lens with a shoulder. This reduced the MOM thickness from 54 mils to 10 mils.

The lens generated in Example 2 using the method diagrammed by FIGS. 1 and 2 is cost effective, capable of going through standard coating machines. The method maximized the imagery relative to the inputted boundary conditions. The results are a cost effective MOM capable of good resolution on the appropriate printer on a cost effective MOM.

The inventive method will be further illustrated by way of the following example:

Assume example boundary conditions of: (i) 720 dpi; (ii) cost is critical; and (iii) thickness of the material needs to be minimized to go through ink jet coating and through ink jet printing machine.

To obtain maximum depth the user maximizes the number of frames, inputting, for example, twelve (12) frames per lenticule or, using the following formula, and assuming a selected LPI value=60, arrives at the number of frames=12:

$$\frac{printer dots \text{/} inch}{lens per inch} = \frac{PDPT}{LPI} = \# interphased frames \qquad ( 10 )$$

Having chosen LPI=60, step 10 calculates a radius and thickness from the following first order approximation of thickness=focal length of lens

$$\begin{matrix}f = \frac{{n}^{′}}{{n}^{′} - 1} \times R & ( 11 ) \\ R = \frac{{n}^{′} - 1}{{n}^{′}} \times R & ( 12 )\end{matrix}$$

where,

f=focal length of lens, or thickness

R=radius of lens

n=index of refraction of material

and calculates the acceptance angle according to

/2=tan⁻¹((1000/2×LPI)/(f−R)), where (13)

Thus, this method design a series of lens for a given index of refraction n′ of the material. LPI and n′ are known and one can balance off the thickness, f, versus the acceptance angle by varying R.

Aspheric lenses can be designed using appropriate lens theories, as well as fly's eyes lenses from two-dimensional lens design criteria. Any other array can be used by using a standard lens equation.

Once a lens array has been theoretically designed, step 10 uses a ray trace program to optimize the thickness relative to the odd size, gain, frames, viewing distance.

Step 12 designs and manufactures a shaped cutting tool to produce the master framing tool for the exclusive process. As previously described, allowance needs to be made in the design of the lens and the tool shaping for shrinkage of the material during extrusion. The shaped tool is used to cut the master extrusion tool. Step 16 produces a MOM using the tool designed and produced at step 12.

Optionally, the MOM generated at step 16 is checked using microscopic examination, including the use of microdensitometers to check required corrections to tooling. Imagery is tested against the manufactured lens material. Any necessary corrections are made to the tooling design generated at step 12 to correct for process aberrations.

Depending on finished imagery and ray trace analysis, an interphasing program such as that shown in FIG. 2 creates the images required of the application. The present invention, however, is not limited to interphasing using computer-based pixel images. In fact, computer generated negatives or photograph negatives can be used to produce an optically interphased piece, for display through the MOM designed at step 10.

It will be understood that computer generated imagery may also be created using layering techniques and composition techniques to frame the scene and add all the appropriate depth cues. Further, information from the ray trace program generated in step 10 is used at step 18 to develop the position of the image behind each MOM lens to obtain maximum effect.

Also, in creating the imagery knowledge of the printing technique relative to prepress limitations, registration and PDP (printer dot pattern) are preferably used to create the appropriate file size while maximizing the imagery.

Steps 20 and 22 may include the imagery file output of step 112 being turned over to a prepress area (not shown) where the imagery is RIPPED to create the appropriate screens for printing or RIPPED directly to a digital press, or ink jet output device. In the case of direct printing appropriate coatings need to be applied to the material to allow for ink adhesion. Appropriate pilot tests may be performed throughout the prepress process. Further, approved plates (not shown) may be generated as the material is printed.

While computer generated imagery for multi-dimensional imagery is well known and the interphasing technology exists with the public domain, the present invention is unique in the use of such factors as encapsulating dimensionally variable optical parameters inherent to the lens configuration, and by encapsulating visual triggers such as depth cueing, light shadowing, and monocular cues. These factors are all presented relative to the lens array and the given dots to optimize the effect relative to what the human eye sees.

Output devices contemplated by this invention encompass, but are not limited to, computer screens, digital picture frames, movie screens, wireless devices, such as phones and PDAs, and any other output device that conveys visual information.

The transmission of the information encapsulated within the method of this invention can proceed through satellites, computers, LAN, WAN, peer-to-peer, Internet, optical pipeline, wireless repeaters, encrypted channels and any other medium whereby visual imagery and/or its components are transmitted for display through micro-optical material.

The present invention has been described in terms of several preferred embodiments. However, various obvious additions and changes to the preferred embodiments are likely to become apparent to persons skilled in the art upon a reading and understanding of the foregoing specification. Further, it will be understood that the specific structure, form and arrangement of parts depicted and described are for purposes of example only, and are not intended to limit the scope of alternative structures and arrangements contemplated by this invention. Instead, the depicted examples are to assist persons of ordinary skill in understanding the principles, features and practical considerations of this invention and, based on the example and other descriptions herein, make and use it and any of its alternative embodiments that will be obvious upon reading this disclosure.

We claim:

1. A method for displaying an image through a microlens sheet, comprising steps of:
inputting a physical constraint data into a retrievable data storage device;
inputting an image quality data into a retrievable data storage device;
retrieving the physical constraint data and the image quality data into a programmable data processor;
calculating a microlens specification data based on the retrieved physical constraint data and the retrieved image quality data, utilizing the programmable data processor;
calculating a microlens processing tool specification data based on the calculated microlens specification data;
manufacturing a microlens processing tool based on the calculated microlens processing tool specification data manufacturing a microlens sheet utilizing the microlens processing tool;
inputting a digitized image into a retrievable storage medium;
retrieving the digitized image into a programmable data processor;
formatting the digitized image into a pixel array based on the calculated microlens specification data;
outputting the pixel array to a printing device;
printing the outputted pixel array on a printable medium; and
displaying the printed outputted pixel array through the microlens sheet.

2. A method according to claim 1, wherein the physical constraint data includes a thickness constraint data.

3. A method according to claim 1 wherein the step of calculating a microlens specification data uses ray tracing.

4. A method according to claim 1 wherein the image quality data is a subjective data having a scalar value corresponding to a subjective image quality criterion.

5. A method according to claim 1 wherein the physical constraint data includes a data describing a performance characteristic of an output device for carrying out the step of printing the outputted pixel array on a printable medium.

6. A method according to claim 1 wherein the step of forming a microlens sheet utilizing the microlens processing tool forms the microlens sheet with an ink-receptive surface.

7. A method according to claim 7 wherein the printable medium is the ink receptive surface.
